(19) United States
(12) Patent Application Publication
(10) Pub. No.: US 2025/0257433 A1
(43) Pub. Date: Aug. 14, 2025

(54) MAGNESIUM-BASED LIGHT METAL MATRIX COMPOSITE MATERIAL AND PROCESS FOR ITS MANUFACTURE

(71) Applicant: Soluterials Verwaltungs und Verwertungs UG, Cottbus (DE)

(72) Inventor: Alla Kasakewitsch, Neubrandenburg (DE)

(73) Assignee: Soluterials Verwaltungs und Verwertungs UG, Cottbus (DE)

(21) Appl. No.: 18/855,232

(22) PCT Filed: Apr. 13, 2023
(86) PCT No.: PCT/EP2023/059694

§ 371 Date: Oct. 8, 2024

(30) Foreign Application Priority Data
Apr. 13, 2022 (DE) 10 2022 109 070.1

(51) Int. Cl. C22C 29/00; C22C 1/051; C22C 29/16

(52) U.S. Cl. CPC C22C 29/005; C22C 1/051; C22C 29/16

(57) ABSTRACT

A metal matrix composite material is made from a powder mixture with magnesium having a purity of at least 95.0% and with separating agent and with hexagonal boron nitride, graphene oxide, molybdenum sulphide and/or other particles having a hexagonal structure, with up to 2% by weight of the release agent and up to 5% by weight of the particles having a hexagonal structure.

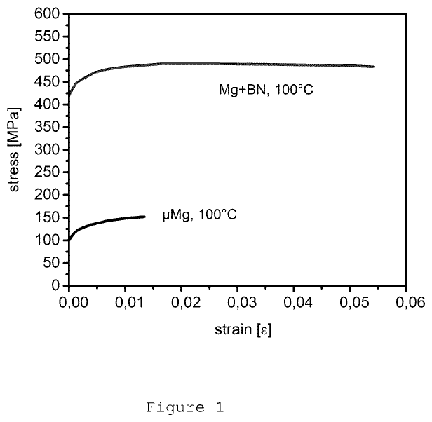

The invention relates to the technical improvement of a magnesium-based metal matrix composite material made from a powder mixture with a composition comprising
Magnesium with a purity of at least 95.0%, and
particles with hexagonal structure, and
separating agent,
   and a process for manufacturing this metal matrix composite material.

Metal matrix composites are called metal matrix composites (MMC) in the English-speaking world. In the presence of magnesium as a metal component, it can be referred to as a magnesium matrix composite.

Magnesium has good corrosion resistance by nature, but insufficient mechanical properties for technical use. In order to improve its mechanical properties, magnesium is alloyed with various alloying elements such as aluminum, copper, manganese, nickel, silicon and/or zinc. A more complete list of alloying elements can be found in “DIN 17007-4:2012-12 Werkstoffnummern—Teil 4: Systematik der Hauptgruppen 2 und 3: Nichteisenmetalle”. Alloying allows the mechanical properties to be improved, but automatically reduces the corrosion resistance.

The most commonly used magnesium die casting alloys AZ91 (tensile strength: 200-260 MPa, elongation at break: 1-6%) and AM50 (tensile strength: 180-230 MPa, elongation at break: 5-15%) are a very good example of this relationship. The increase in strength is achieved for AZ91 with the addition of 8.5-9.1% aluminum and for AM50 with 5.7-6.3% aluminum. However, the corrosion resistance is significantly reduced with increasing aluminum content.

Another group of magnesium-based materials with significantly improved mechanical properties are magnesium alloys alloyed with rare earth elements (REE; German: seltene Erdelemente, SEE).

As an example, two patent applications can be cited here, both of which have improved the mechanical properties such as the yield strength Rp 0.2, but also the creep resistance, with the addition of REE:

DE102009038449B4 relates to a magnesium material in the form of a magnesium alloy alloyed with REE, with a yield strength Rp 0.2 of at least 140 MPa.

DE102008039683A1 relates to a creep-resistant magnesium alloy based on a multi-component system with alloyed SEE.

Both examples are designed for technical applications.

For medical applications, magnesium-based materials are used which must have very good biocompatibility and be biologically absorbable.

Applications DE102018120093A1 and DE102011082210 A1 are listed here as examples.

The mechanical properties are improved by the addition of REE.

The extraction of rare earth elements (REE) poses a sustainability problem. As REEs only occur in low concentrations in deposits, the movement of very large volumes of earth material is required for extraction in industrially relevant quantities. This is followed by processing with sometimes corrosive and highly toxic substances in order to extract the REE in metallic form from the carrier material. This leads to considerable environmental pollution.

Secondly, some REEs themselves are highly toxic and therefore pose a significant health risk to mining and processing personnel. In addition, rare earths often occur in combination with radioactive metals, which release radioactive radiation during mining.

Technically, the REEs have a higher density than magnesium. Scandium has the lowest density at 2.985 g/cm³ and yttrium at 4.472 g/cm³. Other REEs have a density of up to 9.84 g/cm³. These values are well above the density of magnesium at 1.738 g/cm³, and consequently significantly increase the density of SEE magnesium alloys.

The global demand for REE raw materials is increasing significantly, as they are used in almost all high-tech consumer electronics products, green technology components, coatings, and paints.

This invention is based on the task of creating a magnesium-based light metal matrix composite material for technical and especially for medical applications, which can be produced at least at the level of conventional, possibly improved properties such as corrosion resistance, strength, biocompatibility, biological absorption, environmental friendliness, and sustainability, in a simplified manufacturing process using components which are harmless to health.

The above problem is solved by a magnesium-based light metal matrix composite material according to Claim 1 and a process for its manufacturing according to Claim 4. Advantageous embodiments are given in the dependent Claims.

The magnesium-based light metal matrix composite material according to the invention has a composition consisting of
magnesium with a purity of more than 95.0%, preferably more than 99.0% (especially 99.5%), and
up to 2 percent by weight of a separating agent, in particular metallic soap or stearic acid, and
hexagonal boron nitride, graphene oxide, molybdenum sulphide and/or other particles with a hexagonal structure (and preferably only these constituents)—and is characterized according to the invention by a proportion of particles with a hexagonal structure (particularly preferably hexagonal boron nitride) of equal to or less than 5% by weight.

This light metal matrix composite material is produced according to the invention by comminuting the magnesium by means of, for example, water atomization or gas atomization, in particular without prior fractionation, irrespective of particle size (particle size of 0 to 1 mm) or, particularly preferably, mechanically, from the magnesium in the form of granules with an initial granule size of 0 to 5 mm and mixing it with the other constituents.

In the process according to the invention, the mixture is preferably extruded after the mechanical mixing of the components according to the invention, whereby a tensile strength range can be set from 100 MPa to over 450 MPa, immediately after extrusion, even without prior or subsequent heat treatment. Further primary forming processes, such as sintering or 3D printing [additive manufacturing] to form an ingot or semi-finished product or a component with a final contour, are processing methods of the light metal matrix composite powder mixture according to the invention, preferably in such a way (designed, controlled and/or regulated in the process parameters) that no melting phase is produced and in particular the melting limit, in particular of magnesium, is not exceeded.

For the manufacturing and, in particular, the shaping of the magnesium-based light metal matrix composite material according to the invention, an extrusion process suitable for large-scale production is particularly preferred, especially at the end of the manufacturing process. For most common extruded magnesium matrix composites, a forming temperature of at least 450° C. is required after preheating. A subsequent heat treatment is usually carried out to fully compact the composite. For shaping the magnesium-based light metal matrix composite according to the invention, no preheating and a significantly lower shaping temperature is sufficient (in particular so that the melting point is not or only slightly exceeded) in order to achieve a final density and final strength of almost one hundred percent. Subsequent heat treatment is not necessary.

Usually, an extrusion process of powdered metal matrix composites and also powdered magnesium matrix composites takes place using capsules or sleeves that are not made of the material itself. For the magnesium-based light metal matrix composite material according to the invention, the following particularly preferred powder extrusion process is carried out with capsules or sleeves made of intrinsic material or even without the use of capsules or sleeves.

For the production of the magnesium-based light metal matrix composite material according to the invention, pure magnesium is preferably used in 99.5% purity and, in particular, only physiologically harmless materials are used.

The magnesium-based light metal matrix composite according to the invention is fully recyclable without any restrictions. A further important advantage of the invention is the possible use of mechanical comminution of pure magnesium granules to magnesium powder for the mixture of the magnesium-based light metal matrix composite according to the invention. The invention enables sustainable use of raw materials, resource efficiency and environmental friendliness. Since the composite material consists in particular of up to 99.95% pure magnesium (possible purity of the magnesium powder component according to the invention), the return to the secondary market through recycling is highly advantageous without any loss of quality. No SEE, no carcinogenic nanoparticles and no nanotubes are used in the manufacturing process. Only components that are harmless to the human body and also environmentally friendly are used. The extraction of magnesium from salt water, whether from seawater or brines, for example also as a by-product of seawater desalination, for example in the context of drinking water production, also plays a possible advantageous role according to the invention: as a possible environmentally friendly, sustainable and local source of raw materials for the magnesium used according to the invention.

The magnesium-based light metal matrix composite material according to the invention is excellently suited for technical, in particular medical applications due to its three times higher strength compared to pure magnesium, its high creep resistance and its very high purity and thus very good corrosion resistance, which is particularly advantageous for medical technology.

Magnesium can therefore be produced as a material—in accordance with the present invention—with the aid of hexagonal boron nitride and separating agents in particular. The handling and treatment of magnesium is technologically different from other light metals such as aluminum. For example, magnesium is many times more reactive than aluminum. The entire process chain according to the invention must therefore be designed with safety in mind, for example with regard to the risk of explosion. While aluminum can be produced very cost-effectively from recycled aluminum, this is not preferable with magnesium. This is because with aluminum, slight impurities lead to a slight—but acceptable—impairment of electrical and thermal conductivity. Magnesium, on the other hand, especially for medical applications, should preferably be kept free of any impurities throughout the entire process chain, from the raw material to the end material. The purity of the product is of particular importance here.

Similar to hexagonal boron nitride, other hexagonal particles such as graphene oxide (GO) or molybdenum sulphide can be used according to the invention. However, the graphene compounds pose a corrosion problem. Particles such as molybdenum sulphide may be technically interesting in their function according to the invention, but they are toxic. Biocompatibility and biological absorbability would therefore be impaired.

The use of hexagonal boron nitride for the production of magnesium-based light metal matrix composites is therefore particularly advantageous for technical and especially medical applications.

The following exemplary compositions have proven to be particularly suitable as a mixture (in particular with these three components only), especially for subsequent, and in particular also final, extrusion molding:
Mechanically comminuted magnesium granules with a purity of over 95%, preferably over 99%, particularly preferably over 99.5%, especially 99.7%, in fissured grain form and surface, with an average grain diameter of at most 5 mm, preferably at most 1 mm, particularly preferably at most 500 μm, especially 0 to 100 μm;
hexagonal boron nitride powder at most 5%, preferably at most 2%, particularly preferably at most 0.2%, especially 0.05%, by weight of the composition with a purity of at least 95%, preferably at least 97%, particularly preferably at least 98%, especially 98.5%, with an average particle size of at most 50 μm, preferably at most 10 μm, particularly preferably at most 5 μm, especially 2 μm and
Separating agent powder, preferably metal soap or stearic acid, at most 2%, preferably at most 1%, particularly preferably at most 0.1%, especially 0.01%.

State-of-the-art composite materials are usually mechanically alloyed with the highest possible energy in a high-energy ball mill. Ball mills severely limit the production quantity. Very small grinding bowls with a volume of up to 500 ml are filled to a maximum of 20% with the powdered material. This method is only suitable for laboratory testing. For large-scale production applications, this method is only feasible at very high cost.

Although commercially available atomized spherical magnesium powder with a strictly defined particle size and shape is suitable for large-scale applications, it is relatively expensive—and does not necessarily have to be of high shape quality. According to the invention, it has been found that while the highest possible purity of the magnesium starting material is particularly advantageous, the grain shape and particle size only play a minor role. This means that the complex and resource-intensive production of water atomized or gas atomized powders can be dispensed with in favour of simple mechanically comminuted powders. On the one hand, this approach enables an economical and resource-saving end product, and on the other hand, the supply of raw materials is also ensured on a large scale. Magnesium granules with a widely distributed grain size of around 0 to 5 mm are considered the standard product. A wide range of applications can be found in smelting metallurgy and organic chemistry. Magnesium is used, for example, as an additive, reducing agent, alloying element or reaction partner. The possibility of dispensing with energy-intensive remelting processes in accordance with the invention generates additional savings effects. This elimination applies both to the final shaping and to the typical ingot remelting as a subsequent step in the smelting-electrolytic extraction of pure magnesium. Hexagonal boron nitride and separating agent powder, especially metal soap powder, are also materials that are available in large quantities at low cost.

For powder production and mixing, high-energy planetary ball mills are suitable as a grinding system, particularly for smaller throughputs. For large-scale production of magnesium matrix composites, high-energy vibrating mills, especially eccentric vibrating mills, are suitable devices according to the invention.

In the manufacturing process already mentioned, magnesium granulate (with a grain size of 0 to 5 mm, for example) can be processed in a high-energy vibrating mill, particularly in an eccentric vibrating mill, with all components to form the end product (magnesium-based light metal matrix composite material) in a single process step. According to the invention, comminution and mechanical alloying are combined here.

With regard to powder processing according to the invention, shaping methods (in particular for the non-porous material structure according to the invention—porous systems are suitable as filter materials, for example) are diverse. They can basically be divided into methods with a melting phase (for example casting, selective laser melting, powder welding, electron beam welding, build-up welding) or without a melting phase (extrusion (especially at high temperatures: hot extrusion), sintering processes (hot isostatic pressing—HIP), roller compacting (P/M), powder injection molding (PIM), spark plasma sintering (SPS), selective laser sintering (SLS), jet printing).

Sintering processes usually consist of a pre-compaction phase, the sintering process and post-compaction to reduce porosity. In extrusion at high temperatures (hot extrusion), which is particularly preferred according to the invention, the powder is compacted in a single operation in the recipient by the extrusion die. The subsequent thermomechanical bonding (friction welding and bonding of the individual particles of the MMC) can result from the applied pressing pressure in combination with the temperature (particularly preferably below the melting point of the material) within the die and, according to the invention, lead to the shaping of a largely pore-free molded part (ingot, semi-finished product or even finished component).

In 3D printing systems (in particular sintering phase systems), pre-compaction and densification can be achieved according to the invention via the structure and composition of the printing powder and/or a laser-based joining technique (in particular without a melting phase). Possible techniques differ in their work steps. On the one hand, there are pure green compact manufacturing approaches (binder jetting), which only sinter a product separately after shaping, and on the other hand, there are manufacturing approaches in which the sintering process is initialized locally by the laser directly during powder application. The latter process variant has a lower porosity compared to the former, although this usually comes at the cost of higher production requirements and lower production output.

According to the invention, shaping by extrusion at high temperatures is a particularly suitable process for large-scale powder processing. The material throughput rates are of comparable efficiency to conventional mass production processes in the metal industry.

Devices for this purpose are designed according to the invention, for example, as follows.

Extrusion, in conventional extrusion systems for solid material forming, preferably receives a handling aid for powder systems according to the invention in order to transfer the compaction energy applied by the extrusion die to the powder material. In addition to direct powder extrusion, possible methods include, for example, sintering the powder material to form an extrusion billet or using powder-filled metal sleeves based on the powder matrix material (for example magnesium powder in magnesium sleeves). Both variants seal the die side of the recipient (thus preventing the powder material from being blown out through the die) and allow continuous degassing while the press plunger compresses the system and transfers the press pressure into the material for shaping.

The sleeve variant can be more flexible compared to the sintered bolt, with less labor and lower costs. The sleeve system can produce a layer of sleeve material on the outer shell of the pressed profile, which requires subsequent removal by mechanical processing.

For example, the sleeve can be designed without weld seams between its base and sides. For example, in accordance with the invention, this prevents the weld seams, which are usually softer than the sleeve itself, from deforming during the actual extrusion process.

Both cover sides can be mechanically closed and hold the powder in the sleeve during extrusion. An opening in the sleeve allows the release of gas from the powder. By using such a sleeve system, for example, the processing according to the invention can also correspond to a conventional extrusion process in conventional machines or systems.

A further design of the sleeve in accordance with the invention is the use of powder material (in this case magnesium-based light metal matrix composite material) as the main material of the sleeve. In this case, subsequent mechanical processing to remove the sleeve is not necessary. This represents a cost-effective technology for large-scale industrial processes in which sleeve-free powder processing is not implemented.

The following FIGURE shows the properties of the following composition as an example of the invention (“Mg+BN”) in comparison to pure magnesium (“μMg”) from the prior art in a diagram:
Mechanically ground magnesium powder with a purity of 95% [and average grain diameters between 20 and 55 μm];
<3% by weight hexagonal boron nitride powder;
<2% by weight separating agent.

The FIGURE shows a stress/strain diagram.

The FIGURE shows the significantly higher stress curve of the magnesium-based metal matrix composite material according to the invention with peak values for the tensile strength (at 100° C.) in the range of over 450 MPa, compared to the known pure magnesium with maximum values in the range of around 150 MPa.

1. A metal matrix composite material made from a powder mixture with magnesium having a purity of at least 95.0% and with separating agent and with hexagonal boron nitride, graphene oxide, molybdenum sulphide and/or other particles having a hexagonal structure, with up to 2% by weight of the release agent and up to 5% by weight of the particles having a hexagonal structure.

2. The material according to claim 1, wherein the composition comprises no material component other than the magnesium and the particles with hexagonal structure and the separation agent.

3. The material according to claim 1, characterized in that the separating agent is metal soap or stearic acid.

4. The material according to claim 1, characterized in that the powder mixture has an initial size of 0 to 5 mm.

5. A method of manufacturing a magnesium-based light metal matrix composite material made from a powder mixture with magnesium having a purity of at least 95.0% and with separating agent and with hexagonal boron nitride, graphene oxide, molybdenum sulphide and/or other particles having a hexagonal structure, with up to 2% by weight of the release agent and up to 5% by weight of the particles having a hexagonal structure, the method comprising:
step a) crushing the magnesium granulate mechanically,
step b) mixing the material components, and
step c) processing the mixture into an ingot, semi-finished product or component by primary forming or extrusion or sintering or 3D printing.

6. The method according to claim 5, wherein the step of primary forming or extrusion or sintering or 3D printing is carried out in such a way that the melting point of the magnesium-based light metal matrix composite is not exceeded.

7. The method according to claim 5, wherein the step of mixing the material components is carried out simultaneously with or after the start of step a) and/or the particles with hexagonal structure and the separating agent are added to the mixture substantially simultaneously, namely by at most 5 minutes or at most 2 minutes one after the other and/or comprises the steps of mechanically alloying the magnesium and the particles with hexagonal structure and deagglomerating them be-forehand and/or afterwards.

8. The method according to claim 5, wherein the steps of mechanically comminuting the magnesium powder and mixing the material constituents in powder form are carried out in the same apparatus, in a mill, in one operation.

9. The method according to claim 5, wherein the magnesium granules are mechanically comminuted to a particle size of at most 500 μm or at most 100 μm or at most 50 μm.

10. The method according to claim 5, wherein the powder of the particles having a hexagonal structure in the composition:
does not exceed 5% or 2% or 0.1% of its weight, and/or
a purity of at least 95% or at least 97% or at least 98%, and/or
has an average particle size of no more than 50 μm or 10 μm or no more than 5 μm.

11. The method according to claim 5, wherein the separating agent in the composition constitutes at most 2.0% or at most 1.0% or at most 0.8% of its weight.
